(19) United States
(12) Patent Application Publication
(10) Pub. No.: US 2014/0320296 A1
(43) Pub. Date: Oct. 30, 2014

(54) Wireless Control Systems and Methods

(71) Applicants: Robert Thurber, Huntsville, AL (US); Scott Gates, Huntsville, AL (US)

(72) Inventors: Robert Thurber, Huntsville, AL (US); Scott Gates, Huntsville, AL (US)

(21) Appl. No.: 13/873,076

(22) Filed: Apr. 29, 2013

(51) Int. Cl. G08B 21/14

(52) U.S. Cl. CPC G08B 21/14
USPC 340/632

(57) ABSTRACT

The present disclosure relates to a system that has at least one device that detects a hazardous condition in an environment and wirelessly transmits a detection message comprising data indicative of the hazardous condition. Further, the system has logic that wirelessly receives the detection message and transmits a shutdown message to an electrical control system for controlling power supplied to a hot work station based upon the detection message.

### CROSS REFERENCE TO RELATED APPLICATION

This application claims priority to U.S. Provisional Application Ser. No. 61/639,716 entitled System Wireless Control Systems and Methods, filed on Apr. 27, 2012, which is incorporated herein by reference in its entirety.

### BACKGROUND

Drilling and production platforms are often used to drill wells on an ocean floor from which natural resources, e.g., oil and/or gas, can be extracted and processed. Some drilling and production platforms are colossal structures located offshore and far from civilization; however, some drilling and production platforms are located onshore.

There are a number of dangers inherent in the extraction and processing of natural resources through use of oil platforms. In this regard, the natural resources mined by such oil platforms are often volatile in that they are highly combustible. Further, volatile substances, e.g., flammable gases, are often freed from tapped rock shale layers, and such release often poses serious risk to the safety of the individuals working on the oil platform.

### SUMMARY

Generally, embodiments of the present disclosure provide systems and methods for wirelessly controlling power provided to a hot work station in a hazardous environment.

In this regard, the present disclosure relates to a system that has at least one device that detects a hazardous condition in an environment and wirelessly transmits a detection message comprising data indicative of the hazardous condition. Further, the system has logic that wirelessly receives the detection message and transmits a shutdown message to an electrical control system for controlling power supplied to a hot work station based upon the detection message.

Additionally, the present disclosure relates to a method comprising detecting a hazardous condition in an environment by a detection device configured to communicate wirelessly and wirelessly transmitting by the detection device a detection message comprising data indicative of the hazardous condition. Further, the method comprises wirelessly receiving the detection message and transmitting a shutdown message to an electrical control system for controlling power supplied to a hot work station based upon the detection message.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a drilling platform.

FIG. 2 is a block diagram illustrating an exemplary embodiment of a control room computing device, such as is depicted by FIG. 1.

FIG. 3 is a block diagram illustrating an exemplary embodiment of an E-stop, such as is depicted by FIG. 1.

FIG. 4 is a block diagram illustrating an exemplary embodiment of a production platform.

FIG. 5 is a block diagram illustrating an exemplary embodiment of a transducer, such as is depicted by FIG. 3.

FIG. 6 is a block diagram illustrating an exemplary embodiment of a release valve controller, such as is depicted by FIG. 3.

FIG. 7 is a block diagram illustrating an exemplary embodiment of a graphical user interface (GUI) employed by control logic, such as is depicted by FIG. 3.

FIG. 8 is a flowchart illustrating exemplary architecture and functionality of control logic, such as is depicted by FIG. 1.

FIG. 9 is a flowchart illustrating exemplary architecture and functionality of control room control logic, such as is depicted by FIG. 1.

### DETAILED DESCRIPTION

Wireless control systems and methods of the present disclosure wirelessly control managing risks inherent on a drilling and production platform. A wireless system for a drilling platform in accordance with an embodiment of the present disclosure comprises at least one emergency stop (E-stop) and at least one gas detector coupled to respective nodes of a wireless mesh network (WMN). In addition, the wireless system comprises control logic communicatively coupled to a node of the WMN and communicatively coupled to a control system that may contain a plurality of programmable logic controllers (PLCs) or some other control infrastructure. When activated, the E-stop is configured to transmit a wireless signal to the control logic, and the control logic is configured to automatically disable operations of a corresponding hot work station via communication with the control system.

In addition, the gas detector is configured to detect flammable or toxic gas in an environment and to transmit a wireless signal to the control logic indicative of the level of gas in the environment. In response, the control logic is configured to compare the detected level of gas in the environment to a predefined threshold and to automatically shut down a power supply to a corresponding hot work station when the detected level of gas exceeds the predefined threshold via communication with the control system. Alternatively, the gas detector may be programmed with a threshold, and the gas detector sends a discreet alarm message indicative of the hazardous condition when the threshold is exceeded. In response, the control logic can take action based on this discreet message and need not compare the detected gas level.

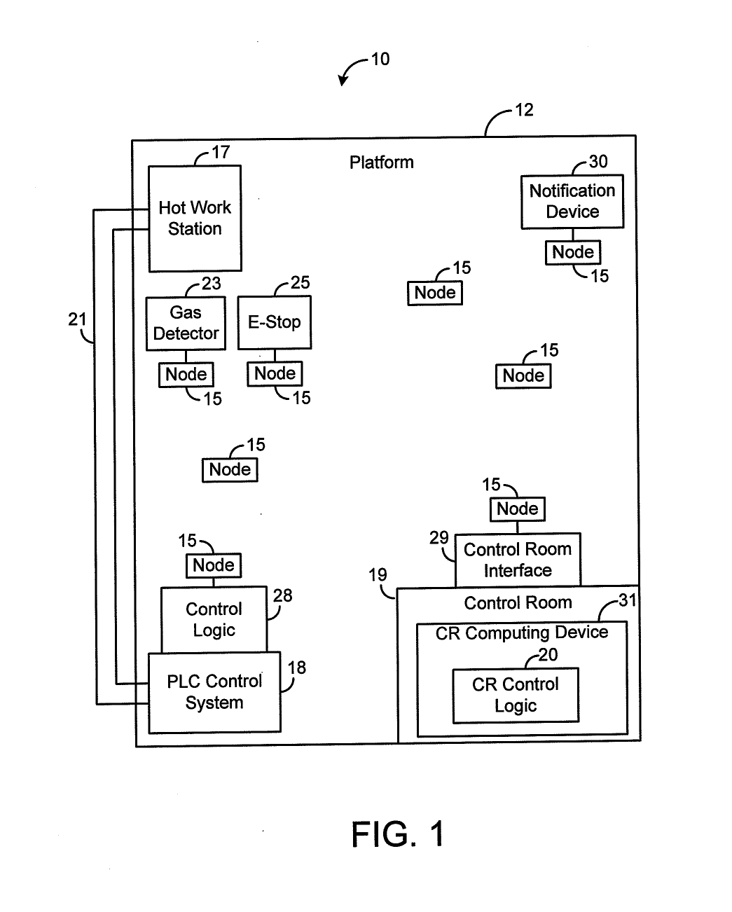

FIG. 1 depicts an exemplary wireless system 10 implemented on a drilling platform 12. The wireless system 10 comprises a plurality of nodes 15 configured to wirelessly communicate with one another via a wireless protocol. In one embodiment, the wireless system 10 comprises a wireless mesh network (WMN), but different types of wireless networks are possible in other embodiments. U.S. Patent Publication No. 2010/0074163, entitled “Systems and Methods for Controlling Data Paths for Wireless Networks” and filed on May 8, 2009, which is incorporated herein by reference, describes various wireless mesh networks that may be used to implement the wireless system 10.

In an embodiment wherein a WMN is employed to effectuate communication between the nodes 15, the nodes 15 may each comprise a radio transceiver. Each radio transceiver is configured to both receive and transmit radio signals.

In one embodiment, the drilling platform 12 comprises at least one hot work station 17, a programmable logic circuit or controller (PLC) control system 18 containing at least one PLC (not shown), and a control room 19. The PLC control system 18 comprises or is communicatively coupled to control logic 28 that controls the PLC control system 18.

FIG. 1 depicts only one hot work station 17, but other numbers of hot work stations 17 may simultaneously be in operation in other embodiments. In such a case each node corresponding to a given sensor/detector and/or E-stop associated with a given hot work station is uniquely encoded such that control logic 28 may identify a particular hot work station, e.g., hot work station 17, associated with a sensor/detector or E-stop from which the control logic 28 receives a signal, even if it is not necessarily physically collocated, as will be described in more detail hereafter.

The hot work station 17 comprises a plurality of tools (not shown) and/or mechanical equipment (not shown), for example, drills, welding torches, or other machinery, in operation. The hot work station 17 is coupled to the PLC control system 18 via an electrical connection 21, and the control system 18 delivers at least one power signal across the electrical connection 21 to the hot work station 17. The power signal transmitted by the PLC control system 18 is for supplying power to the array of tools and/or equipment (not shown) that are electrically coupled to the hot work station 17.

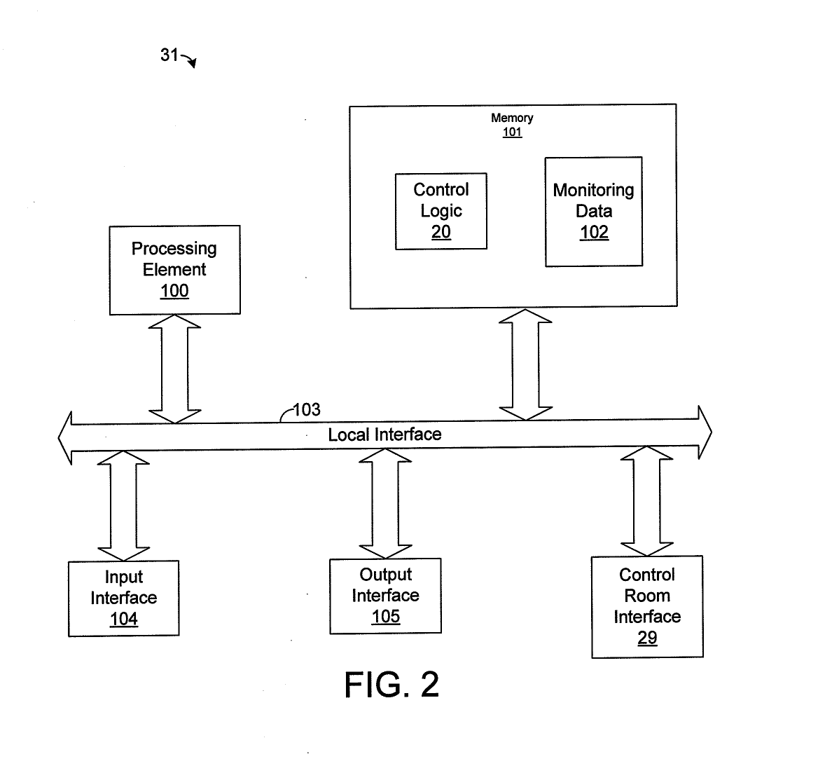

In the often volatile environment of the drilling platform 12, the active electrical power supplied by the PLC control system 18 may be immediately shut down if dangerous conditions are encountered by crew members resulting from gas leaks or other accidents. In one embodiment, the control room 19 comprises control room (CR) control logic 20 for monitoring and managing the hot work station 17. The CR control logic 20 may be implemented in a computing device 31. The computing device 31, described further with reference to FIG. 2, may be, for example a desktop or personal computer, laptop computer, or tablet. Notably, different implementations are possible in other embodiments.

As shown by FIG. 1, the wireless system 10 has a plurality of nodes 15 that form a wireless mesh network, though other types of wireless networks may be formed by the nodes 15 in other embodiments. In one embodiment, the wireless system 10 comprises at least one gas detector 23 and at least one E-stop 25 coupled to respective nodes 15. In one embodiment, the wireless system 10 further comprises a notification device 30 coupled to a respective node 15.

Although FIG. 1 depicts only one gas detector 23 and one E-stop 25, any number of gas detectors 23 and E-stops 25 are possible in other embodiments. For example, each gas detector 23 or E-stop 25 may be associated with one or more hot work stations 17 such that an input from the gas detector 23 or E-stop 25 may shut down each of the plurality of hot work stations 17, and each hot work station 17 may be associated with a plurality of gas detectors 23 or E-stops 25 such that an input from any of the gas detectors 23 or E-stops 25 may shut down the hot work station 17.

The network 10 further comprises the control logic 28 identified herein. The control logic 28 is coupled to the PLC control system 18 and a control room interface 29. The control room interface 29 is coupled to the CR control logic 20 of the CR computing device 31 of the control room 19. The control logic 28 and the control room interface 29 are coupled to respective nodes 15 of the system 10, that communicate wirelessly and enable wireless communication among the control logic 28, the control room 19, and the other components coupled to the other nodes 15 of the system 10, e.g., the gas detector 23, the E-Stop 25, and the notification device 30, which is described further herein.

The gas detector 23 is configured to detect flammable and/or toxic gas in an environment, such as the hot work station 17, and to transmit a wireless message indicative of the detected gas level to the control logic 28 and to the control room interface 29. For example, in the event of a flammable gas leak, the level of flammable gas in the environment increases and any sparks or flames created by active equipment in the hot work station 17 can create fires or explosions on the platform 12 if the gas reaches the hot work station 17. In one embodiment, the gas detector 23 periodically transmits a wireless message indicative of the detected gas level in the environment to the control logic 28 and the CR control logic 20 at regular intervals. In other embodiments, other communication schemes may be used. As an example, the gas detector 23 may be configured to transmit such a message only when the detected gas level exceeds a predefined threshold, thereby reducing the number of messages that are communicated.

In another embodiment, the gas detector 23 may transmit a wireless message indicating detection by the gas detector 23 that a gas level threshold has been exceeded to the notification device 30. In this regard, the wireless message transmitted may simply activate the notification device 30. However, other information regarding gas detection may be transmitted in the wireless message transmitted to the notification device 30 in other embodiments.

The notification device 30 is configured to alert workers or other individuals within the vicinity of the gas detector 23 or in other areas of the platform 12 that a dangerous condition may exist. In this regard, the notification device 30 may comprise a sound device (not shown) for producing an audible alert, e.g., a horn. In addition, the notification device may comprise a visual device (not shown) for producing a visual alert, e.g., a strobe light. Thus, upon receipt of the wireless signal from the gas detector 23, the notification device 30 is configured to activate any one of a number of alert devices that alerts individuals of the potential threat.

In one embodiment, the control logic 28 is configured to receive the wireless message from the gas detector 23 and to compare the detected gas level to a predefined threshold value. If the detected gas level is at or below the predefined threshold, the control logic 28 takes no action. However, if the detected gas level exceeds the predefined threshold, the control logic 28 communicates with the control system 18 via the node 15 and the control logic 28, in order to automatically shut down the electrical power to the corresponding hot work station 17 such that fires or explosions resulting from the gas leak are avoided.

As described hereinabove, a plurality of gas detectors 23 may be implemented at various locations on the platform 12, and each gas detector 23 may correspond to one or more hot work stations 17. Where a plurality of gas detectors 23 are employed on a platform 12, the wireless message transmitted by the gas detectors 23 may contain an identifier that identifies the hot work station 17 corresponding to the detector 23 that transits the wireless message indicative of increased gas levels. The control logic 28 receives the message from the detector 23 that initiated the wireless signal, identifies the hot work station 17 that is associated with the detector 23 based upon the identifier, and shuts down the corresponding hot work station 17 by cutting off electrical power to the hot work station 17 such that accidents are avoided. If multiple hot work stations 17 are associated with the gas detector 23, the control logic 28 cuts off power to each of the associated hot work stations 17.

In another embodiment, a crew member (not shown) in the control room 19 monitors the wireless signals received from the gas detector 23 and manually initiates a shutdown of the hot work station 17 when the gas level becomes excessive in the opinion of the crew member. In such embodiment, the crew member may shut down the hot work station 17 by activating an associated E-stop 25 such that electrical power is prevented from flowing to the hot work station 17, but different techniques for shutting down the power are possible in other embodiments.

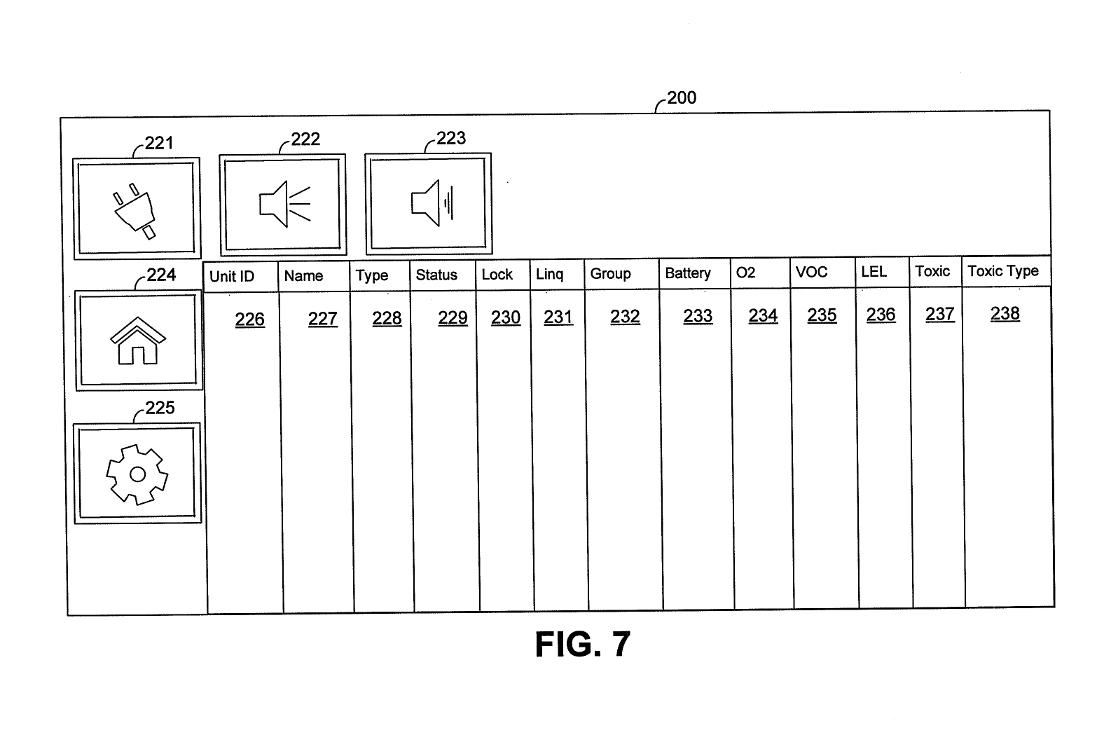

In another embodiment, the control logic 28 and/or the CR control logic 20 in the control room 19 stores a log of the detected gas levels for each gas detector 23. Each message indicative of a detected gas level preferably includes an identifier that identifies the gas detector 23 that transmitted the message, a value indicative of the detected gas level, and a timestamp indicating the time that the indicated gas level was detected. Such information may be displayed to a user of the CR computing device 31, which is described further herein with reference to FIG. 7. In addition, the control logic 28 and/or the CR control logic 20 may store such information into the log so that the log can later be analyzed to determine the gas level detected by each gas detector 23 at any time of interest. The timestamp can be provided from the sensor node using a system wide global time reference (absolute or relative) or a local time reference; however, the time reference could also be provided via the control logic 20 after message receipt.

Note that the control logic 28 and the CR control logic 20 may be implemented in hardware, software, firmware, or any combination thereof. In the embodiment depicted by the FIG. 1, the control logic 28 and the CR control logic 19 are shown to be implemented separately at different locations. In other embodiments, it is possible for the functionality of the control logic 28 and the CR control logic 20 to be implemented at the same location, such as within the same program.

The E-stop 25, when activated, is configured to transmit a wireless message to the control logic 28 in order to automatically stop the supply of electrical power to the corresponding hot work station 17. In this regard, the E-stop 25 is associated with one or more hot work stations 17, and the E-stop 25 is activated by a crew member in an emergency situation in order to immediately shut down the associated hot work station 17 by cutting off power to the associated hot work station 17. In one embodiment, the E-stop 25 comprises a button (not shown) that is activated when pressed, but other types of E-stops are possible in other embodiments. The wireless message transmitted by the E-stop 25 contains an identifier that identifies the E-stop or the hot work station 17 with which it is associated, and based on such identifier, the control logic 28 signals the PLC control system 18 to stop supplying electrical power to the associated hot work station 17 upon receiving the signal from the E-stop 25.

Note that it is unnecessary for there to be direct communication between the node 15 coupled to a gas detector 23 or E-stop 25 and the CR control logic 20 or the control logic 28 that is to act upon the message. As an example, it is possible for such node 15 to be out of range or occluded from the CR control logic 20 or the control logic 28. However, when a WMN is used in the system, each node 15 functions as a router for the messages transmitted by other nodes 15. In this regard, each node 15 is configured to forward messages from other nodes 15 such that a message can traverse the network from node-to-node until the node arrives at its intended destination.

Further note that the gas detector 23, the E-stop 25, and the notification device 30 may be portable. Thus, they may be moved to various locations on the platform 12 without ceasing to operate. In one embodiment, an E-stop 25 may be given to each crew member such that each crew member has the capability of immediately shutting down a particular hot work station 17 in the event of an emergency. Furthermore, due to the portable nature of the E-stops 25, an E-stop 25 associated with a particular hot work station 17 need not be located at or near such hot work station 17 in order to shut down the hot work station 17 by activation of the E-stop 25. Thus, in one embodiment, E-stops 25 for each hot work station 17 may be located within the control room 19 as well as on individual crew members or pieces of equipment in the hot work station 17.

The system disclosed within employs a number of optional failsafe measures. In one embodiment, each E-stop 25 periodically transmits a wireless message, referred to herein as a “heartbeat signal,” to the control logic 28. The control logic 28 is configured to receive the heartbeat signal from each E-stop 25 in order to ensure that the E-stop 25 has a functioning wireless path through the wireless system 10 to communicate with the control logic 28. If the E-stop 25 does not have a functioning wireless path of communication with the control logic 28, any activation of the E-stop 25 is not transmitted to the control logic 28 and the electrical power to the hot work station 17 is not shut down thereby creating potential danger for crew members. In order to ensure that a wireless path between the E-stop 25 and the control logic 28 is functioning, the E-stop 25 transmits the heartbeat signal at regular intervals, such as, for example, one second intervals. If the control logic 28 fails to receive a heartbeat signal from a given the E-stop 25 within a certain time period of the last message received from such E-stop, the control logic 28 determines that the wireless path between the E-stop 25 and the control logic 28 is down, and the E-stop 25 has no path of communication with the control logic 28. Upon such determination, the control logic 28 causes the PLC control system 18 to shut down the electrical power to the associated hot work station 17 and notifies the CR control logic 20 in the control room 19 of the shutdown. Accordingly, any loss of wireless communication between the E-stop 25 and the control logic 28 causes the control logic 28 to automatically shut down the hot work station 17 associated with the E-stop 25 in order to avoid accidents that may result due to the loss of wireless communication.

In another embodiment, the control logic 28 may be configured to generate a warning rather than shutting down the associated hot work station 17 when communication is lost. As an example, the control logic 28 may transmit a warning message to the CR control logic 20, which displays the warning to a crew member. Such message preferably identifies the associated hot work station 17 and the E-stop 25 for which communication has been lost. In response to the warning, the crew member may investigate the loss of communication in order to assess whether there is an emergency that would warrant shut down of the associated hot work station 17.

Note that similar techniques may be used to detect when communication has been lost with a gas detector 23 and to respond to such an event. In addition, the wireless network may be used to monitor sensors, detectors, and other types of devices as may be desired.

In one embodiment, the wireless mesh network is organized such that it is immune to any single-occurring fault with a node or a communication path. For example it may be organized such that any two nodes in the network have redundant paths between them. In this fashion, the communication path is more robust and more tolerant of isolated problems. The wireless mesh network is capable of dynamically choosing the best path and delivering messages via these redundant nodes when failures occur.

For example, as described by U.S. Patent Pub. No. 2010/0074163, when one node (“source node”) desires to send a message to another node (“destination node”), a route discovery procedure is initiated in which the nodes communicate with one another to find a path through the network. Thereafter, the found path may be used to send messages from the source node to the destination node, which preferably transmits an acknowledgment upon receiving the message. If the source node fails to receive an acknowledgment within a predefined time period of sending the message, the source node assumes that the message did not arrive at the destination node. The source node may then attempt to re-transmit the message. If the message is not acknowledged after a certain number of attempts, the source node assumes that the path to the destination node has been lost and initiates another route discovery process to find a new path to the destination node. Using such techniques, the network automatically discovers when a path between two nodes has been lost and dynamically discovers a new path to the extent that such a new path is available.

In one embodiment, CR control logic 20 may be configured to monitor the health of the wireless mesh network in real-time. Such health may be defined by the signal strength of communication strengths in the network coupled with or taken separately from the number of redundant communication paths available to each of the devices (e.g., gas detectors or E-stops) in the network. Data indicative of the health of the network may be displayed to a crew member via the CR computing device 31, which is described further herein.

In an embodiment wherein crew members monitor data in the control room 19, a crew member may make decisions of network operation (i.e., whether to continue power to a hot work station 17 or add an additional hot work station to the network) based on the data displayed indicative of the health of the network. In this regard, it may be safest that hot work stations are not erected and made operational unless the network is immune to any singly occurring node failure.

As described hereinabove, the CR control logic 20 may monitor existing communication paths or discover alternative (e.g., redundant) communication paths to devices on the network. In this regard, the network may still be operational even if some nodes and paths have failed. Notably, the CR control logic 20 makes a determination that a communication path is not operating properly or not operating as a result of transient conditions, for example, or an indication of permanent node failure. Based upon data reported by the CR control logic 20, the crew members may determine whether conditions are safe to begin another hot work station for example or whether it would be advantageous to restore the wireless mesh network to full redundancy before beginning another hot work station.

Note that in one embodiment, the health of the wireless mesh network can be obtained from a wireless routing protocol. For example, exemplary wireless protocols SNAP and ZigBee are both configured to monitor network health. The CR control logic 20 may be configured to interface with data obtained by such wireless protocols and use such data to report health of the network to the crew members. Such interface may be effectuated by exposing the CR control logic 20 to the wireless protocol systems for this purpose.

A graphical user interface (GUI) (not shown) implemented on the CR computing device 31 may display data indicative of the network health to crew members for making these judgments, as described hereinabove. In addition, the CR control logic 20 may automatically monitor data indicative of the health of the network. In this regard, the CR computing device 31 may store data indicative of thresholds for signal strength and/or operation of communication paths. The CR control logic 20 may compare data indicative of the health of the network with such thresholds to determine if operations should be shut down or limited based upon the health of the network. In this regard, the thresholds may be indicative of and reflect predetermined safety policies. In such a scenario, crew members are not left to make a decision, which may be prone to human error. Such automatic determinations may prohibit the operation of a new hot work station until minimum safety requirements are met (such as ensuring that any two nodes have at least two unique paths within the network). In this fashion, it can be ensured that hot work stations are only started when there is confidence that the WMN can survive a singly occurring fault.

In situations where the mesh network health and redundancy is not monitored in real-time, it is desirable that the mesh network support explicit route delivery. In this sense, CR control logic 20 can issue a test message to nodes in the network and request that two independent paths be tested. In this sense, it is possible to explicitly verify redundant routes for message delivery.

In another embodiment, it is desirable to test full operation of the system before deploying a live hot work station. In this case, a test mode is supported. Via the control room interface, an authorized crew member can request a test mode of operation. In this case, a message is sent from the CR control logic 20, via the wireless mesh network, to the nodes 15 attached to an E-stop 25 or gas detector 23. In response, the nodes 15 enter into a test mode of operation. Crew members can then activate the E-stop 25, for example, to generate an alarm message and verify receipt by the CR control logic 20. Alternatively, in cases where all messages are routed via the node 15 coupled to the control room interface 29, no special test mode need be employed at the sensor nodes. Instead, the CR control logic 20 could simply enter into a test mode of operation where alarms are used to verify communication paths between the control room 19 and the nodes 15 connected to the gas detectors 23 and E-stops 25 but are ignored for the purpose of controlling power delivered to a given hot work station. Crew members could then activate the E-stop or gas detector to generate an alarm and so that the operational status of the gas detectors 23, E-stops 25, and wireless network can be verified before deploying the hot work station.

FIG. 2 depicts an exemplary embodiment of the CR computing device 31 depicted in FIG. 1. As shown by FIG. 2, the CR computing device 31 comprises the CR control logic 20 and monitoring data 102 stored within memory 101.

The control logic 20 generally controls the operation of the CR computing device 31, as will be described in more detail hereafter. It should be noted that the control logic 20 can be implemented in software, hardware, firmware or any combination thereof. In an exemplary embodiment illustrated in FIG. 2, the control logic 20 is implemented in software and stored in memory 101.

Note that the control logic 20, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the CR computing device 31 depicted by FIG. 2 comprises at least one conventional processing element 100, such as a digital signal processor (DSP) or a central processing unit (CPU), that communicates to and drives the other elements within the CR computing device 31 via a local interface 103, which can include at least one bus. Further, the processing element 100 is configured to execute instructions of software, such as the control logic 20. An input interface 104, for example, an interface for a keyboard, keypad, or mouse, (not shown) can be used to input data from a user of the CR computing device 31, and an output interface 105, for example, an interface to a printer or display screen (e.g., a liquid crystal display (LCD)), can be used to output data to the user. In addition, the control room interface 29 enables the device 31 to communicate with nodes 15 (FIG. 1).

The monitoring data 102 is stored in memory 101, as indicated hereinabove. The monitoring data 102 is any data indicative of the attributes or operations of the system 10. In this regard, the monitoring data 102 may be set up data that identifies the layout of the system 10 or any data received from any one of the components of the system 10 communicating through one of the respective nodes 15.

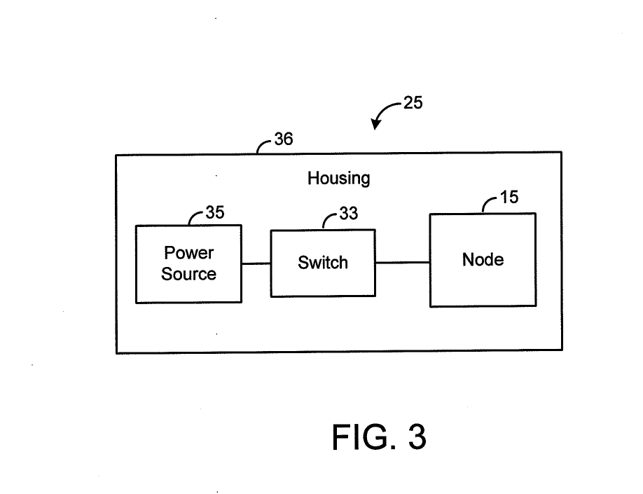

FIG. 3 depicts an exemplary embodiment of the E-stop 25 of FIG. 1. In one embodiment, the E-stop 25 comprises a switch 33, a power source 35, and a node 15 positioned within a housing 36. In one embodiment, the E-stop 25 is portable, but E-stop 25 may be mounted at any desired location such that it is stationary.

The switch 33 is coupled to the node 15, and the power source 35, such as, for example, a battery. The power source 36 is configured to supply power to the switch 33.

In one embodiment, the E-stop 25 comprises a button (not shown) coupled to the switch 33, and the switch 33 transitions from an open state to a closed state when the button is pressed. In such an embodiment, the switch 33 is in an open state when the E-stop 25 is deactivated (the button is not pushed). However, other techniques for transitioning the switch 33 between an open position and a closed position are possible in other embodiments.

In operation, the E-stop 25 is activated by a crew member who desires to immediately shut off power to the corresponding hot work station 17 (FIG. 1), for example during an emergency situation. Notably, when the E-stop 25 is activated such that the switch 33 is transitioned to a closed state (e.g., the button is pressed), the node 15 transmits a wireless message to the control logic 28 indicating that the E-stop has been activated. The transmitted message includes data indicative of a unique identifier indentifying the E-stop 25 and/or the associated hot work station 17. In addition, the transmitted message may further comprise data indicative of a timestamp indicating the time of activation. Based on the identifier included in the transmitted message, the control logic 28 identifies the hot work station 17 corresponding to the E-stop 25 and instructs the PLC control system 18 to shut off electrical power to the hot work station 17, as set forth above.

In one embodiment, the hot work station 17 may be deployed rapidly and in an ad-hoc fashion by an installer. In this scenario, the node 15 associated with the E-stop 25 is not preconfigured to specific hot work station(s). In addition, the E-stop 25, once installed and associated with a particular hot work station 17 may thereafter be reconfigured and associated with another different hot work station as the topology and needs of the drilling platform change.

As an example, an authorized crew member may obtain an E-stop or a gas detector from a supply area located within the drilling platform 12. The crew member may then associate the obtained device(s) with a specific hot work station that is being deployed on the drilling platform.

Association of a device with a particular hot work station may be accomplished in any number of ways. For example, data indicative of an identifier correlating a particular selected device, e.g., an E-stop, gas detector, or notification device, with a particular workstation may be stored on the CR computing device 31 or by the control logic 28 in local memory (not shown). In this regard, the device may have dip switches or an electronic interface that enables a crew member to program the device with the identifier that associates the device with the hot work station.

Thus, when the E-stop transmits a message indicating that the E-stop has been activated and the message includes the identifier, the CR control logic 20 or the control logic 28 can identify which hot work station needs to be deactivated based upon the unique identifier. Therefore, the PLC control system 18 may be directed by the control logic 28 to shut down the appropriate power supply for a given hot work station. One method for associating nodes 15 to a hot work station is to utilize control logic interface to “map” or re-associate a device to a new logical grouping or hot work station. This process might include inputting the device's serial number or physical network address (MAC address) and identifying information of the hot work station into a computer interface (not shown) of the device. The CR control logic 20 would then communicate with the device (e.g., gas detector 23 or E-stop 25) requesting the device's identifying information (e.g., serial number or MAC address and the hot work station identifying information). In response, the device transmits a message to the CR control logic 20 containing the identifying information. This method could also invoke any network joining protocols that are required by the specific wireless mesh network in use, if required. In one embodiment, an identifier of the hot work station could be provisioned (via the wireless communication protocol) on the device so that the identifier physically resides in the node and/or device. In this sense, it is reprovisioned with a new identifier during this method. In another embodiment however, the node may always contain a unique address which is then, by way of the method disclosed above, simply re-associated with a new logical grouping or new hot work station. This association would be stored in a repository as part of the CR control logic 20 so that crew members and/or CR control logic 20 would be able to determine which hot work station a node belongs. Note that standard password protection or other authentication procedures could be employed by the CR control logic 20 to prohibit unauthorized crew members from changing hot work station assignments to gas detectors 23 or E-stops 25.

As a mere example, in one embodiment, each hot work station 17 (“hot work station identifier”) is assigned a unique identifier, and each node 15 is also assigned a unique identifier (“node identifier”). The node identifier of a given node 15 may be the node's network identifier (i.e., the identifier that is used to identify the node in the wireless communication protocol implemented by the network) or another type of identifier. Further, for the nodes 15 physically connected to a gas detector 23 or E-stop 25, the node identifier may be used to identify such connected gas detector 23 or E-stop 25. In other words, the same identifier may be used both for a node 15 and the gas detector 23 or E-stop 25 that is connected to such node 15.

A table mapping node identifiers to hot work station identifiers may be stored in the control room 19 or at some other location. When a gas detector 23 or E-stop 25 is commissioned for use with a particular hot work station 17, such table is updated to map the identifier of the hot work station 17 to the node identifier for the gas detector 23 or E-stop 25 to be used with such hot work station 17. Thus, when a message from the node 15 is later received, it can be determined based on such mapping to which hot work station 17 the message pertains. As an example, if a message is received from the node 15 connected to an E-stop 25 indicating that the E-stop 25 has been activated, the CR control logic 20 may be configured to use the message's node identifier to lookup in the foregoing table the associated hot work station identifier, thereby determining which hot work station 17 is to be shut down in response to the message.

Note that the aforementioned table may also be communicated to the control logic 28 such that this logic 28 can determine to which hot work station 17 a received message pertains without having to communicate with the CR control logic 20.

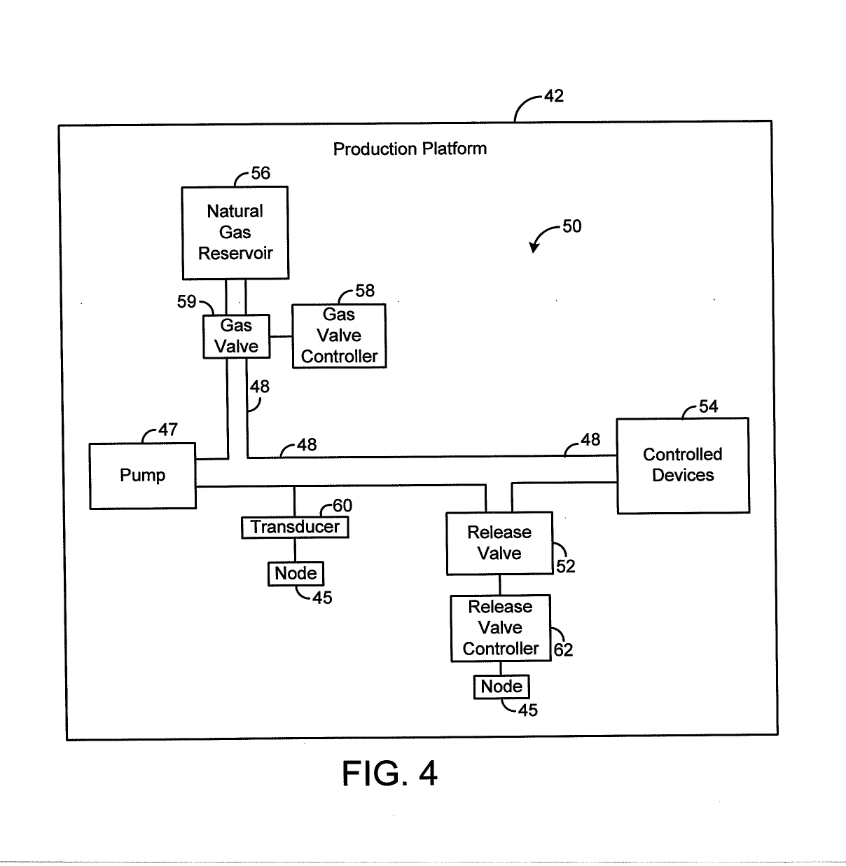

FIG. 4 depicts an exemplary embodiment of a wireless pneumatic system 50 implemented on a production platform 42. In one embodiment, the pneumatic system 50 comprises a plurality of nodes 45 configured to wirelessly communicate with one another and with at least one node 15 (FIG. 1) of a wireless system 10 (FIG. 1) via a wireless protocol, as will be discussed in more detail hereafter.

In one exemplary embodiment, the nodes 45 are members of the wireless mesh network implemented by the nodes 15, and the pneumatic system 50 is located at a remote location from the wireless system 10 set forth in FIG. 1. As an example, the production platform 42 may be positioned up to several miles from the platform 12 of FIG. 1 provided that at least one node 45 is within range of at least one node 15.

As shown by FIG. 3, the production platform 42 comprises a pump 47, such as, for example, an air compressor, coupled to a pipe 48 of the pneumatic system 50. The pump 47 is configured to supply air pressure to power the pneumatic system 50. The pneumatic system 50 further comprises a release valve 52 and one or more controlled devices 54 coupled to pipes 48 of the system 50. The release valve 52 is configured to release the pressure within the pipes 48 (e.g., vent to the atmosphere) when opened such that the pneumatic system 50 loses pressure.

The controlled devices 54, such as, for example, tools, drills, and other equipment and machinery, are operated based on pressure from the pneumatic system 50. When the pressure in the pneumatic system 50 falls below a threshold, the controlled devices 54 cease to operate.

The pneumatic system 50 further comprises a natural gas reservoir 56 coupled to a pipe 48 of the pneumatic system 50. In this regard, natural gas is a byproduct of crude oil drilling, and the natural gas may be used on the production platform 42. In one embodiment, the natural gas may be released into the pipes 48 in order to increase pressure within such pipes 48 as may be desired. Thus, when the pressure within the pipes 48 becomes too low, a gas valve controller 58 actuates a gas valve 59 in order to release natural gas from the reservoir 56 into the pipes 48 thereby increasing the pressure within the pipes 48 so that the pneumatic equipment can continue to operate.

The pneumatic system 50 further comprises a transducer 60 that measures the pressure within the pipes 48 of the system 50. In one embodiment, the transducer 60 is configured to detect the pressure within the pipe 48, to compare the pressure to a predefined threshold, and to transmit an electrical signal to the node 45 when the measured pressure is within a certain range (e.g., above an upper threshold).

In response to such measured pressure, the node 45 may transmit a wireless message via wireless protocol to a specified destination indicating the detected condition. In one embodiment, the node 45 transmits a wireless message to the node 15 of the CR control logic 20 (FIG. 1) within the control room 19 (FIG. 1) such that a crew member within the control room can shut down the pneumatic system 50. In this regard, the crew member manually activates an E-stop 25 (FIG. 1) that corresponds to the pneumatic system 50, and the E-stop 25 is coupled to a node 15 positioned within the control room 19. The E-stop 25 transmits a wireless message, as set forth above, referred to hereafter as a “release valve actuation (RVA) message,” to a node 45 coupled to a release valve controller 62 located on the production platform 42.

In another embodiment, the node 45 coupled to the transducer 60 transmits a wireless message to the node 15 of the control logic 28 (FIG. 1). In such embodiment, the control logic 28 automatically transmits an RVA message to the node 45 of the release valve controller 62 in order to control the controller 62.

The release valve controller 62 is coupled to the release valve 52 of the pneumatic system 50, and the controller 62 is configured to actuate the release valve 52 upon receiving an RVA message. In this regard, the release valve controller 62 receives the RVA message from the E-stop 25 or the control logic 28 and opens the release valve 52 in order to release pressure from the pipes 48 thereby shutting down the pneumatic system 50. Thus, any natural gas in the pipes 48 is vented to the atmosphere, the pressure within the pipes 48 is released, the controlled devices 54 are shut down, and accidents are avoided. Accordingly, the pressure of the pneumatic system 50 is monitored and controlled remotely via the transducer 60 and the controller 62 of the pneumatic system 50. Note that, rather than communicating with the nodes 15 of the platform 12, the nodes 45 may communicate with control logic at other locations for reporting the pressure readings and receiving RVA messages.

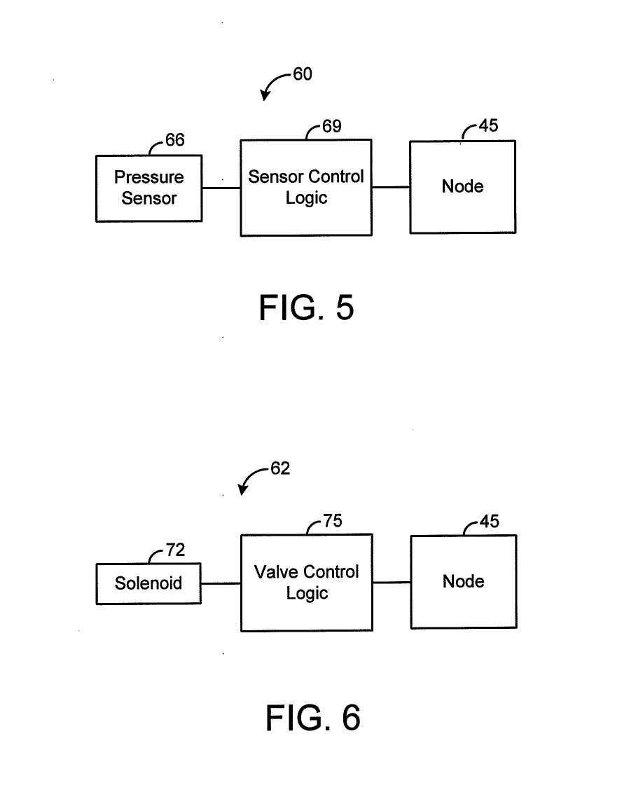

FIG. 5 depicts an exemplary embodiment of the transducer 60 of FIG. 3. In one embodiment, the transducer 60 comprises a pressure sensor 66 coupled to sensor control logic 69, which can be implemented in hardware, software, firmware, or any combination thereof. The pressure sensor 66 is configured to detect the pressure within the pipe 48 (FIG. 3) and transmit a pressure reading to the sensor control logic 69. The logic 69 is configured to receive the pressure reading from the sensor 66, to compare the pressure reading to a predefined threshold, and to transmit an electrical signal to the node 45 indicating that the pressure is too high when the pressure reading exceeds the predefined threshold. In one embodiment, the node 45 receives the electrical signal from the logic 69 and transmits a wireless message via a wireless protocol to the control room 19 (FIG. 1), as set forth above. However, the node 45 may transmit the wireless message to other destinations in the wireless system 10 (FIG. 1) in other embodiments. Accordingly, the transducer 60 converts the pneumatic pressure reading to an electrical signal that can be transmitted via wireless networks.

FIG. 6 depicts an exemplary embodiment of the release valve controller 62 of FIG. 3. In one embodiment, the release valve controller 62 comprises a solenoid 72 coupled to valve control logic 75, which may be implemented in hardware, software, firmware, or any combination thereof. The solenoid 72 is physically coupled to the release valve 52 (FIG. 3) in order to allow mechanical actuation of the release valve 52. The valve control logic 75 is configured to control the operation of the solenoid 72. In this regard, the valve control logic 75 is coupled to the node 45 and receives the RVA message from the E-stop 25 (FIG. 1) or the control logic 28 (FIG. 1), as the case may be. Upon receiving the RVA message, the control logic 75 controls the solenoid 72 such that the solenoid 72 actuates the release valve 52 and releases pressure from the pneumatic system 50 thereby shutting down the pneumatic system 50. Accordingly, the controller 62 allows the pneumatic system 50 to be controlled remotely such that emergency shutdowns are facilitated and accidents are avoided.

Although the pressure transducer 60 (including sensor control logic and wireless node) and the release valve controller 62 are depicted as separate components in the system, it is possible that the two could be combined into one device. In this embodiment, the pressure transducer and valve controller are collocated and the release valve solenoid could be activated directly from the same logic recognizing a change in line pressure without the need to send a wireless message. However, it may still be advantageous to utilize the wireless node for communicating periodic readings and/or health of the module to the CR control logic 20. Similarly, the sensor and control logic could be implemented as a more generic module by way of allowing various analog or digital inputs (that could be connected to sensors other than pressure transducers) along with typical signal input conditioning circuits; and including a variety of analog or digital outputs. In this manner, the modules could be used as rapid building blocks for assembling other components in the wireless system. For example, the modules and onboard logic and wireless nodes could be configured (with the appropriate sensors) as temperature detectors, gas detectors, motion sensors, or low fuel sensors for example. The logic and outputs could be configured to send wireless messages, disable power sources, and energize solenoids, as a few non-limiting examples. In this manner the system can be extended easily to any number of wireless sensing and remote control applications.

In another embodiment, the production platform (FIG. 3) or the drilling platform (FIG. 1) can be combined into heterogeneous networks. Transducers 60 and release valve controllers 62 may coexist with E-stops 25 and gas detectors 23 or possibly other sensors and activators not yet described. Nodes may be part of a wireless mesh network all within the same platform or may also be part of a broader network consisting of multiple platforms. In such a case, each platform may be configured with its own control logic 20 or this control logic could be accessible remotely either via a wireless network from nearby platforms (if feasible) or potentially using other long range communication methods (cellular, satellite communication, underwater cabling, etc).

In this fashion, an entire fleet of heterogeneous drilling platforms and production platforms—some manned and some not manned—can be monitored and managed by centrally located resources. Even if each platform contained logic to make isolated safety shutoff decisions, it may still be advantageous to collect performance analytics on each platform to determine overall safety occurrences and rate of safety incidents. In this manner, other maintenance aspects of the network(s) and devices can be performed as well. For example, when equipped to do so, node firmware and/or control room software could be updated by centrally located server to ensure that all nodes and all platforms are all operating off of the same configuration.

In another embodiment, where it may not be practical to maintain a continuous long range communication link to a particular platform, a helicopter or a boat can be configured with communication nodes such that it can dynamically join the mesh network on the platform or communicate via a separate (wireless) communication link. In this fashion, a helicopter could fly by a platform for visual inspection but also rapidly interrogate the sensors, equipment, and/or control logic to obtain pertinent details about the status of the equipment on the platform. This would save many man hours by avoiding having to board the platform and manually taking readings, as well as avoiding human exposure to hazardous conditions unnecessarily.

FIG. 7 depicts an exemplary graphical user interface 200 that may be displayed to a display device (not shown), and hence to a crew member (not shown) in control room 19, communicatively coupled to the output interface 105 (FIG. 2).

The GUI 200 comprises a plurality of buttons 221-225 for performing particular functionality and a plurality of columns 226-239 for displaying information to the crew member for use in controlling the wireless system 10 (FIG. 1).

In this regard, button 221, when selected, powers on or off the CR computing device 31 (FIG. 1) and/or the control logic 20. When button 224 is selected, the control logic 20 displays the GUI 200 as shown in FIG. 7. When button 225 is selected, the control logic 20 displays a GUI (not shown) for entering set up information related to the devices on in the wireless system 10, e.g., gas detector 23, E-stop 25, and notification device 30. In this regard, the crew member may enter association data that associates a particular device with a particular hot work station. In addition, the crew member may associate a plurality of devices as a group. For example, with reference to FIG. 1, the settings operation may allow a crew member to associate the gas detector 23, the E-stop 25, and the PLC control system 18 with the hot work station 17, and so forth.

The information displayed to each column 226-239 is described in more detail hereafter. In this regard, column 226 is entitled “Unit ID” (hereinafter referred to as the “Unit ID column 226”), which is indicative of unit identification (or identifier). Unit ID column 226 exhibits an identifier for each of the devices that are communicatively coupled to the wireless network made up of the nodes 15 (FIG. 1) (or in another embodiment nodes 15 and nodes 45 (FIG. 4)). As an example, with reference to FIG. 1, the Unit ID column 226 may comprise a list containing an identifier for the gas detector 23, the E-stop 25, the notification device 30 and/or the PLC control system 18 (or control logic 28).

Column 227 is entitled “Name” (hereinafter referred to as the “Name column 227”), which is indicative of given name for the device listed in the Unit ID column 226. As an example, the Name column 227 may comprise the phrase “Gas Detector A” associated with the identifier in the Unit ID column 226 for the gas detector 23, and so forth for each device identified in the Unit ID column 226. Such names may be more easily recognizable or discernible to the crew member that is viewing the GUI 200.

Column 228 is entitled “Type” (hereinafter referred to as the “Type column 228”), which is indicative of the type of device. For example, the various types of devices may include gas detector, E-stop, notification device, or PLC control system.

Column 229 is entitled “Status” (hereinafter referred to as the “Status column 229”), which is indicative of a status of the associated device. For example, the various types of devices may include gas detector, E-stop, notification device, or PLC control system. As an example, the Status column 229 may display a red circle (not shown) that indicates that the associated device (e.g., an E-stop) has been activated or the associated gas detector has detected an amount of gas above a threshold such that further action is desired.

Column 230 is entitled “Lock” (hereinafter referred to as the “Lock column 230”). The lock column displays an identifier associated with the corresponding listed device in the Unit ID column 226 that indicates whether setting associated with the device can be changed. Notably, in one embodiment, when a crew member activates the control logic 20, he/she may log on to the system. In one embodiment, a particular user identifier and password may be associated with “administrative” privileges such that the administrative user may change settings or particular settings associated with the device listed.

Column 231 is entitled “Ling” (hereinafter referred to as the “Ling column 231”). The control logic 20 may periodically check the signal strength or line quality of a communication connection with the device listed. Based upon the signal strength or line quality of the line tested, the control logic 20 may display an identifier indicating the health of the communication link to the device in the Linq column 231.

Column 232 is entitled “Group” (hereinafter referred to as the “Group column 232”). As described hereinabove, the crew member may associate a plurality of devices with one another into a “family.” If a plurality of devices is associated, the control logic 20 may display an indicator in the Group column 232 that indicates to what family the device belongs.

Column 233 is entitled “Battery” (hereinafter referred to as the “Battery column 233”), which is indicative of the battery status of the battery of the device identified in the Unit ID column 226. For example, if the battery of the gas detector 23 is at 20%, control logic 20 (FIG. 2) may display a red indicator indicating that the battery is running low. In one embodiment, the control logic 20 may display the actual percentage of the battery.

Column 234 is entitled “O2” (hereinafter referred to as the “O2 column 234”), which is indicative of the amount of oxygen detected by a gas detector. In one embodiment, data indicative of the parts per million (ppm) of oxygen in a sample taken by the gas detector is displayed in the O2 column 235 corresponding to the gas detector listed in the Unit ID column 226.

Column 235 is entitled “VOC” (hereinafter referred to as the “VOC column 235”), which is indicative of the amount of volatile organic compound (VOC) detected by a gas detector. In one embodiment, data indicative of the parts per million (ppm) of any VOC in a sample taken by the gas detector is displayed in the VOC column 235 corresponding to the gas detector listed in the Unit ID column 226.

Column 236 is entitled “LEL” (hereinafter referred to as the “LEL column 236”), which is indicative of lower explosive limits (LEL) corresponding to the listed device. In this regard, the device may be a gas detector that is testing an air sample for gas, propane, or methane. If an amount is detected, the control logic 20 may display a value indicative of the PPM of the amount detected in the air sample.

Column 237 is entitled “Toxic” (hereinafter referred to as the “Toxic column 237”), which is indicative of a particular toxin, e.g., H2S or sodium chloride, that may be contained in a sample of gas taken. Note that the detected gas may be configurable via the settings button 225.

Finally, Column 238 is entitled “Toxic Type” (hereinafter referred to as the “Toxic Type column 238”), which is indicative of type of gas detected in the air sample.

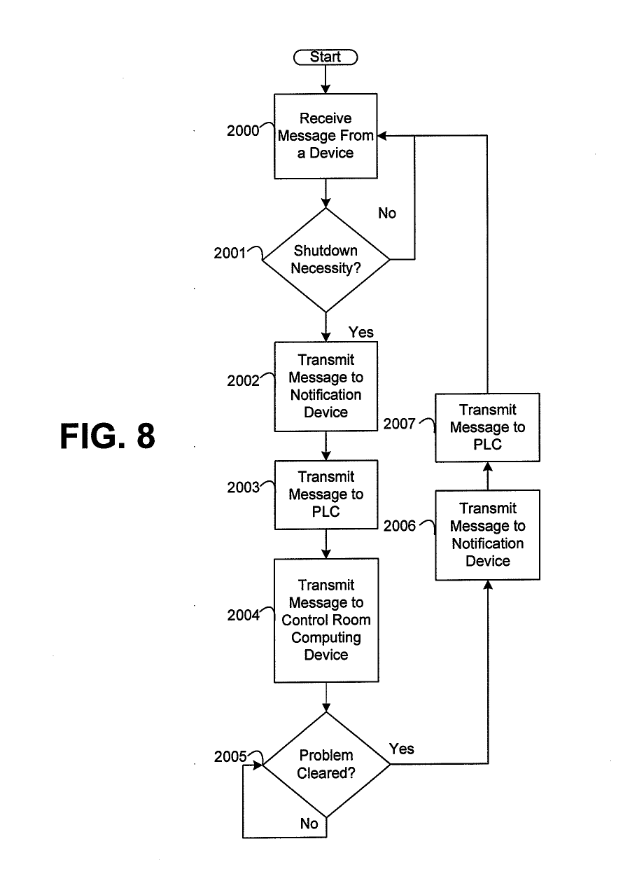

FIG. 8 is a flowchart depicting exemplary architecture and functionality of an aspect of the control logic 28 (FIG. 1).

In step 2000, the control logic 28 receives a message from a device. Note that the message received me be from any device communicatively coupled to the control logic 28. For example, the gas detector 23 and/or the E-stop 25 may transmit messages to the control logic 28.

In step 2001, the control logic 28 determines if a shutdown of power to the hot work station 17 is necessitated by the received message. As an example, a crew member (not shown) may depress a button on the E-stop 25, and the E-stop 25 may transmit a message to the control logic 28 indicating that the button has been pressed. In another example, the gas detector 23 may detect high levels of a dangerous gas and transmit a message to the control logic 28 indicating such detection.

If a shutdown is not indicated by the received message, the control logic 28 does nothing yet continues to look for received messages in step 2000. However, if the message indicates that a shutdown is necessitated, in step 2002, the control logic 28 transmits a message to the notification device 30. In addition, in step 2003, the control logic 28 transmits a message to the PLC control system 18 indicating that power is to be shutdown on the hot work station 17. Further, in step 2004, the control logic 28 may transmit a message to the control room computing device 31.

In step 2005, the control logic 28 may determine that the problem that initiated the alert has cleared. For example, a crew member in the control room 19 may check gas levels and determine that the problem has dissipated or power no longer needs to be shut down. In such a scenario, the CR control logic 20 may transmit a message to the control logic 28 indicating that the problem has cleared. If the problem clears, the control logic 28 may transmit a message to the notification device in step 2006 to deactivate notifications and transmit a message to the PLC in step 2007 to reinitiate power to the hot work station 17.

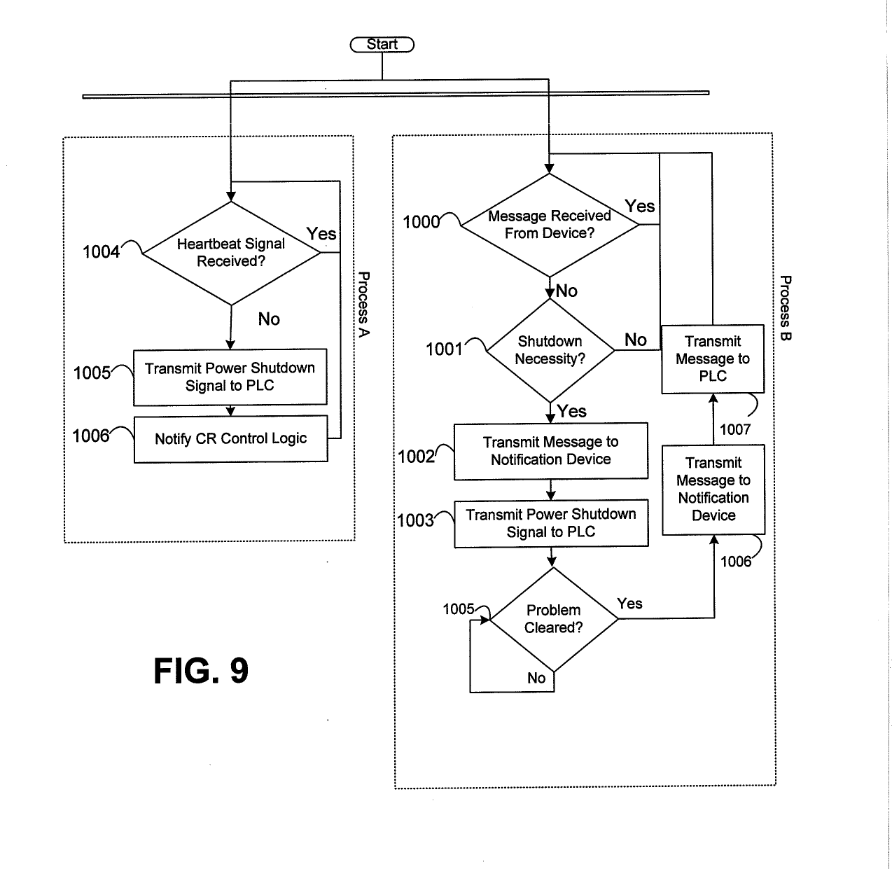

FIG. 9 is a flowchart depicting exemplary architecture and functionality of an aspect of the CR control logic 20 (FIG. 1). The flowchart depicts two processes, including process A and B. Each of the processes A and B may execute simultaneously during operation of the wireless system 10.

In process A, in step 1004, the CR control logic 20 determines if a heartbeat signal has been received that was scheduled to be received. In this regard, as described hereinabove, in order to check communication in the wireless network, the devices (e.g., gas detector 23 and E-stop 25) periodically transmit a heartbeat signal from their respective nodes 15 at a predetermined interval that is known to the CR control logic. Thus, the CR control logic 20 is expecting a message from the device transmitting the message at the time when the device is to transmit the heartbeat signal.

If the CR control logic 20 receives the heartbeat signal at the expected time, the CR control logic 20 continues to listen for heartbeat signals in step 1004. If not, the CR control logic 20 transmits a power shutdown signal to the PLC control system 18 in step 1005, which in turn deactivates power to the appropriate hot work station 17. In addition, in step 1006, the CR control logic 20 transmits a signal to the notification device 30 to take notification measures, i.e., set off an audible and/or visual alarm.

In process B, in step 1000, the CR control logic 20 determines if a message has been received from a device. As described hereinabove, the devices may be, for example, a gas detector 23 and/or E-stop 25.

In step 1001, the CR control logic 20 determines if shutdown is necessary in step 1001. If the message does not indicate that shutdown is necessitated by the received message, the CR control logic 20 continues to listen for messages in step 1000.

However, if the message indicates that a shutdown is necessitated, in step 1002, the CR control logic 20 transmits a message to the notification device 30. In addition, in step 1003, the CR control logic 20 transmits a message to the PLC control system 18 indicating that power is to be shutdown to the hot work station 17.

In step 1005, the CR control logic 20 may determine that the problem that initiated the alert has cleared. For example, a crew member in the control room 19 may check gas levels and determine that the problem has dissipated or power no longer needs to be shut down. In such a scenario, the CR control logic 20 may transmit a message to the notification device in step 1006 to deactivate notifications and transmit a message to the PLC in step 1007 to reinitiate power to the hot work station 17.

In various embodiments described above, wireless control systems are described in the context of drilling and production platforms. However, similar techniques may be used in order to wirelessly control equipment, objects or personnel in other applications and systems. As an example, techniques described herein for performing an emergency shutdown of a hot work station 17 may be used to perform emergency shutdowns of other types of equipment, such as manufacturing equipment or equipment in other industrial applications. In addition, messages indicating various types of events detected by sensors may be wirelessly communicated, as described herein, for performing various tasks and functions. As an example, any sensor for detecting a hazardous condition may similarly provide a warning of the hazardous condition similar to the techniques described herein for the gas detectors. Yet other applications and actions are possible in other embodiments.

Now, therefore, the following is claimed:

1. A system, comprising:
at least one device configured to detect a hazardous condition in an environment and wirelessly transmit a detection message comprising data indicative of the hazardous condition;
logic configured to wirelessly receive the detection message, the logic further configured to transmit a shutdown message to an electrical control system for controlling power supplied to a hot work station based upon the detection message.

2. The system of claim 1, wherein the electrical control system is configured to deactivate power to the hot work station upon receipt of the shutdown message.

3. The system of claim 1, wherein the device is a gas detector configured to detect the presence of a hazardous gas, the gas detector further configured to wirelessly transmit the detection message when the hazardous gas is detected.

4. The system of claim 1, wherein the device is an E-stop configured for manual activation when hazardous conditions are realized, the E-stop further configured to wirelessly transmit the detection message when manually activated.

5. The system of claim 1, further comprising a notification device configured to wirelessly receive an activation message comprising data indicative of the detection message and initiate at least one notification based upon the received activation message.

6. The system of claim 5, wherein the notification is an audible alert.

7. The system of claim 5, wherein the notification is a visible alert.

8. The system of claim 1, further comprising a control room computing device, the control room computing device comprising control room control logic configured to receive the detection message from the at least one device, determine if power should be shutdown at the hot work station, and transmit the shutdown message to the electrical control system.

9. The system of claim 1, wherein the logic is further configured to display data indicative of the environment based upon a wirelessly received status message received from the at least one device.

10. The system of claim 1, wherein the logic is further configured to receive a heartbeat signal from the at least one device, the logic further configured to transmit the shutdown message to the electrical control system based upon non-receipt of the heartbeat signal.

11. The system of claim 1, wherein the logic is further configured to associate the at least one device with the hot work station.

12. The system of claim 11, wherein the device is configured to store data indicative of an identifier uniquely identifying the device.

13. The system of claim 12, wherein the logic is further configured to receive data indicative of the identifier and associate the device with an identifier identifying the hot work station.

14. The system of claim 1, wherein the logic is configured to monitor a first communication path and a second communication path to the device, the first communication path being different that the second communication path.

15. The system of claim 14, wherein the logic is configured to display data indicative of the first communication path and the second communication path to the device.

16. The system of claim 15, wherein the logic is further configured to disallow operational activities related to the hot work station or the environment if the first communication path and the second communication path are not working properly.

17. A method, comprising:
detecting a hazardous condition in an environment by a detection device configured to communicate wirelessly;
wirelessly transmitting by the detection device a detection message comprising data indicative of the hazardous condition;
wirelessly receiving the detection message; and
transmitting a shutdown message to an electrical control system for controlling power supplied to a hot work station based upon the detection message.

18. The method of claim 17, further comprising deactivating power by the electrical control system to the hot work station upon receipt of the shutdown message.

19. The method of claim 17, wherein the device is a gas detector and further comprising:
detecting the presence of a hazardous gas via the gas detector; and
wirelessly transmitting by the gas detector the detection message when the hazardous gas is detected.

20. The method of claim 17, wherein the device is an E-stop and further comprising:
wirelessly transmitting by the E-stop the detection message when the E-stop is manually activated.

21. The method of claim 17, further comprising:
wirelessly receiving by a notification device an activation message, the activation message comprising data indicative of the detection message; and
initiating at least one notification based upon the received activation message.

22. The method of claim 21, wherein the initiating further comprises activating an audible alert.

23. The method of claim 21, wherein the initiating further comprises activating a visible alert.

24. The method of claim 17, further comprising:
receiving the detection message from the at least one device;
determine if power should be shutdown at the hot work station; and
transmitting the shutdown message to the electrical control system.

25. The method of claim 17, further comprising:
displaying data indicative of the environment based upon a status message wirelessly received from the at least one device.

26. The method of claim 17, further comprising:
receiving a heartbeat signal from the at least one device;
transmitting the shutdown message to the electrical control system based upon non-receipt of the heartbeat signal.

27. The method of claim 17, further comprising associating the at least one device with the hot work station.

28. The method of claim 27, further comprising storing, by the device, data indicative of an identifier uniquely identifying the device.

29. The method of claim 28, further comprising:
receiving data indicative of the identifier; and
associating the device with an identifier identifying the hot work station.

30. The method of claim 17, further comprising monitoring a first communication path and a second communication path to the device, the first communication path being different that the second communication path.

31. The method of claim 30, further comprising displaying data indicative of the first communication path and the second communication path to the device.

32. The method of claim 31, further comprising:
automatically disallowing operational activities related to the hot work station or the environment if the first communication path and the second communication path are not working properly.
